(19) United States
(12) Patent Application Publication
(10) Pub. No.: US 2025/0326391 A1
(43) Pub. Date: Oct. 23, 2025

(54) VEHICLE CONTROL APPARATUS

(71) Applicant: TOYOTA JIDOSHA KABUSHIKI KAISHA, Toyota-shi (JP)

(72) Inventor: Eiichiroh MURATA, Ashigarakami-gun (JP)

(73) Assignee: TOYOTA JIDOSHA KABUSHIKI KAISHA, Toyota-shi (JP)

(21) Appl. No.: 19/063,449

(22) Filed: Feb. 26, 2025

(30) Foreign Application Priority Data
Apr. 22, 2024 (JP) 2024-068998

(51) Int. Cl. B60W 30/09; B60W 30/095

(52) U.S. Cl. CPC B60W 30/09; B60W 30/0953; B60W 30/0956; B60W 2554/801; B60W 2554/802

(57) ABSTRACT

A driving support apparatus is configured to perform an alert to a driver of a host vehicle when there is an approaching vehicle that is located in an alert area set in a front side area or a rear side area of the host vehicle and is approaching the host vehicle. The driving support apparatus determines whether or not there is a median strip between the host vehicle and the approaching vehicle, when there is the approaching vehicle. The driving support apparatus does not perform the alert when there is the median strip between the host vehicle and the approaching vehicle.

### TECHNICAL FIELD

The present disclosure relates to a vehicle control device configured to perform a vehicle control for reducing a collision risk with an object when a collision condition is satisfied, the collision condition being satisfied when the collision risk is equal to or greater than a threshold value.

### BACKGROUND

Conventionally, there has been known a vehicle control apparatus configured to perform a vehicle control for reducing a collision risk with an object when the collision risk becomes high. The vehicle control is a control for alerting a driver and/or a control for decelerating a vehicle. For example, a vehicle control apparatus described in Patent Document 1 (hereinafter referred to as a “conventional apparatus”) determines whether or not both of the following conditions 1 and 2 are satisfied when there is a preceding vehicle and a further preceding vehicle.
Condition 1: A distance between the preceding vehicle and the further preceding vehicle is shorter than a threshold.
Condition 2: A subtraction value acquired by subtracting a speed of the further preceding vehicle from a speed of the preceding vehicle is equal to or greater than a threshold.

When both of the conditions 1 and 2 are satisfied, there is a high possibility that the distance between the preceding vehicle and the further preceding vehicle shortens, and there is also a high possibility that the preceding vehicle rapidly approaches the further preceding vehicle. In this case, the conventional apparatus performs a braking preparation for increasing a brake oil pressure in advance. The braking preparation enables a responsive brake control even if the preceding vehicle decelerates (brakes) suddenly due to the presence of the further preceding vehicle.

Patent Document 1: Japanese Patent Application Laid-Open No. 2004-106588

### SUMMARY

When the preceding vehicle changes lanes after the further preceding vehicle decelerates, the preceding vehicle is not affected by the deceleration of the further preceding vehicle. Even in such a case, both of the above conditions 1 and 2 can be satisfied. Accordingly, when the preceding vehicle changes lanes after the further preceding vehicle decelerates, there is a high possibility that the braking preparation, which is performed by satisfying both of the conditions 1 and 2, is unnecessary.

The present disclosure is made to address the above problem. That is, one of the objects of the present disclosure is to provide a vehicle control apparatus can increase a possibility of performing the vehicle control appropriately in response to the deceleration of the further preceding vehicle, and also reduce a possibility of performing the unnecessary vehicle control, even when a deceleration of the preceding vehicle is delayed in response to the deceleration of the further preceding vehicle.

A vehicle control apparatus according to the present disclosure (hereinafter, referred to as the “present disclosure apparatus”) is configured to perform a vehicle control for reducing a collision risk representing a possibility that a host vehicle collides with an object (step 340) when a collision condition is satisfied (“Yes” at step 335, “Yes” at step 365), the collision condition being satisfied when the collision risk is equal to or greater than a threshold value.

The vehicle control apparatus is configured to:
determine whether or not the collision condition is satisfied using a first index value (further preceding vehicle TTC) representing the collision risk of a further preceding vehicle (step 335) when both of a following condition and a trajectory condition are satisfied (“Yes” at step 325),
   the following condition being satisfied when a preceding vehicle which is present in front of the host vehicle is following the further preceding vehicle which is present in front of the preceding vehicle,
   the trajectory condition being satisfied when the host vehicle and the preceding vehicle are traveling along a further preceding vehicle trajectory representing a trajectory traveled by the further preceding vehicle; and
determine whether or not the collision condition is satisfied using a second index value (preceding vehicle TTC) representing the collision risk of the preceding vehicle (step 335) when at least one of the following condition and the trajectory condition is not satisfied (“No” at step 325).

The present disclosure apparatus determines whether or not to perform the vehicle control using the first index value representing the collision risk of the further preceding vehicle when both of the following condition and the trajectory condition are satisfied. In a case where both of the following condition and the trajectory condition are satisfied, there is a high possibility that the preceding vehicle decelerates without changing lanes when the further preceding vehicle decelerates. In other words, there is a high possibility that the deceleration of the further preceding vehicle is transmitted to the preceding vehicle. In a case where the further preceding vehicle decelerates, the present disclosure apparatus can reduce a possibility of performing unnecessary vehicle control when the preceding vehicle changes lanes. Furthermore, the present apparatus can increase a possibility of being able to perform the vehicle control appropriately even when the deceleration of the preceding vehicle is delayed in response to the deceleration of the further preceding vehicle.

### BRIEF DESCRIPTION OF THE DRAWINGS

FIG. 1 is a schematic system configuration diagram of a vehicle control apparatus according to an embodiment of the present disclosure.

FIG. 2 is a drawing for illustrating a distance relation among host vehicle, preceding vehicle, and further preceding vehicle.

FIG. 3 is a flowchart illustrating a vehicle control routine executed by a CPU of an ECU shown in FIG. 1.

FIG. 4 is a flowchart illustrating a following condition determination subroutine executed by the CPU of the ECU shown in FIG. 1.

FIG. 5 is a flowchart illustrating a trajectory condition determination subroutine executed by the CPU of the ECU shown in FIG. 1. FIG. 6 is a drawing for illustrating a lateral distance, a deflection angle and a lateral speed of each of the host vehicle and the preceding vehicle.

### DETAILED DESCRIPTION

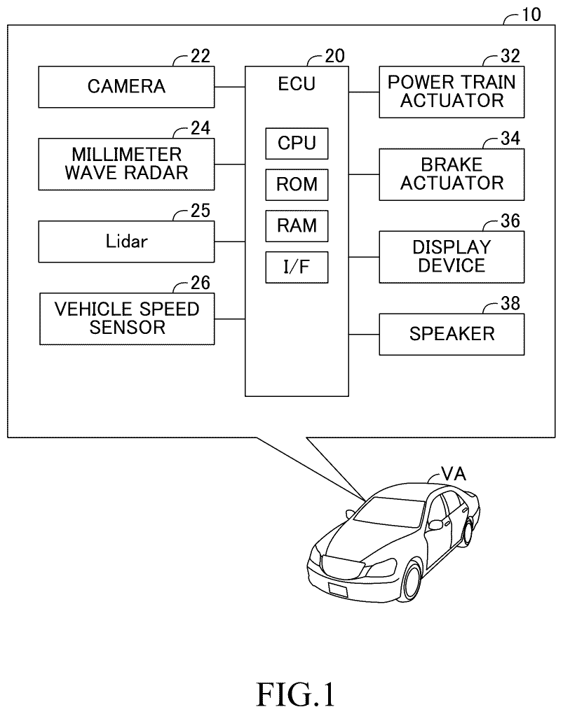

As shown in FIG. 1, a vehicle control apparatus 10 (hereinafter referred to as “the present apparatus 10”) is applied to a host vehicle VA. The present apparatus 10 comprises components shown in FIG. 1.

An ECU 20 performs a vehicle control for reducing a collision risk with an object. For example, the vehicle control is a deceleration control for decelerating the host vehicle VA.

In this specification, the “ECU 20” is an electronic control unit with a microcomputer as a main part. The ECU 20 is also referred to as a control unit, a controller and a computer. The microcomputer includes a CPU (processor), a ROM, a RAM, and an interface (I/F), etc. Functions realized by the ECU 20 may be realized by multiple ECUs.

A camera 22 acquires image data by capturing a scenery in front of the host vehicle VA. The camera 22 acquires camera object information and white line information based on the image data. The camera object information includes a position of an object located in front of the host vehicle VA relative to the host vehicle VA. The white line information includes a position of a white line on a road where the host vehicle VA is traveling relative to the host vehicle VA. The camera 22 transmits the camera object information and the white line information to the ECU 20.

A millimeter wave radar 24 transmits millimeter waves in front of the host vehicle VA, and acquires radar object information by receiving the millimeter waves that are reflected by the object. The radar object information includes a position of the object relative to the host vehicle VA and a relative speed Vr of the object relative to the host vehicle VA. The millimeter wave radar 24 transmits the radar object information to the ECU 20.

The millimeter wave radar 24 is arranged in a position (for example, near a license plate at a front end of the host vehicle VA) where some of the millimeter waves transmitted by the millimeter wave radar 24 passes under a preceding vehicle VB and is reflected by a further preceding vehicle VC that is traveling ahead of the preceding vehicle VB. Accordingly, the millimeter wave radar 24 can detect the further preceding vehicle VC.

The preceding vehicle VB is a vehicle that is located in front of the host vehicle VA, is traveling in the same direction as the host vehicle VA, and is closest to the host vehicle VA. The ECU 20 detects the preceding vehicle VB based on the camera object information, the radar object information, and a LIDAR object information described below.

The further preceding vehicle VC is a vehicle that is located in front of the preceding vehicle VB, is traveling in the same direction as the host vehicle VA, and is closest to the preceding vehicle VB. The ECU 20 detects the further preceding vehicle ahead VC based on the radar object information.

The Lidar 25 emits light in front of the host vehicle VA, and acquires the Lidar object information by receiving the reflected light that is reflected by the object. The Lidar object information includes a position of the object relative to the host vehicle VA and a relative speed of the object relative to the host vehicle VA. The Lidar 25 transmits the Lidar object information to the ECU 20. The Lidar 25 is arranged above the millimeter wave radar 24.

A vehicle speed sensor 26 measures a vehicle speed Vs, which represents a speed of the host vehicle VA. The ECU 20 acquires a measurement value of the vehicle speed sensor 26.

A power train actuator 32 changes a driving force generated by a driving device (e.g., an internal combustion engine and/or an electric motor) of the host vehicle VA. A brake actuator 34 controls a braking force applied to the host vehicle VA. A display device 36 displays an alert screen described below. A speaker 38 outputs a buzzer sound described below.

### Outline of Operation

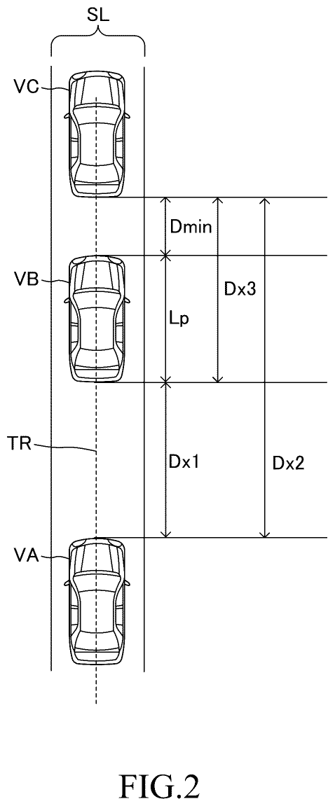

The ECU 20 identifies the preceding vehicle VB and the further preceding vehicle VC based on the camera object information, the radar object information, and the Lidar object information. In a case where the preceding vehicle VB and the further preceding vehicle VC are present, the ECU 20 normally performs a vehicle control when a collision condition is satisfied. The collision condition is satisfied when a TTC of the preceding vehicle VB (hereinafter, referred to as a “preceding vehicle TTC”) is equal to or smaller than a threshold time Tth. The TTC is an abbreviation for Time to Collision. The TTC represents a time which it takes for the object to collide with the host vehicle VA. The ECU 20 acquires the TTC by dividing the distance between the host vehicle VA and the object by the relative speed Vr of the object. The ECU 20 acquires the preceding vehicle TTC by dividing a distance Dx1 (referring to FIG. 2) between the host vehicle VA and the preceding vehicle VB by the relative speed Vr of the preceding vehicle VB. The TTC can also be expressed as an index value representing a collision risk of the object. The shorter the TTC, the higher the collision risk. When the preceding vehicle TTC is equal to or smaller than the threshold time Tth, the collision risk of the preceding vehicle VB is equal to or greater than a threshold value.

However, there is a high possibility that the preceding vehicle VB decelerates suddenly when the preceding vehicle VC decelerates, because the preceding vehicle VB decelerates after approaching the further preceding vehicle VC. In this case, if vehicle control is started when the preceding vehicle TTC is equal to or smaller than the threshold time Tth, a start timing of the vehicle control is delayed.

In the present embodiment, in a case where both of a following condition and a trajectory conditions are satisfied when the preceding vehicle VB and the further preceding vehicle VC are present, the ECU 20 determines that the collision condition is satisfied when a TTC of the further preceding vehicle VC (hereinafter referred to as a “further preceding vehicle TTC”) is equal to or smaller than the threshold time Tth, and performs the vehicle control. A method for acquiring the further preceding vehicle TTC is described later. The further preceding vehicle TTC may be referred to as a “first index value”, and the preceding vehicle TTC may be referred to as a “second index value”.

Both of the following condition and the trajectory condition are satisfied when there is a high possibility that the deceleration of the further preceding vehicle VC is transmitted to the preceding vehicle VB (in other words, that the preceding vehicle VB decelerates due to the deceleration of the further preceding vehicle VC). In more detail, the following condition is satisfied when the preceding vehicle VB is following the further preceding vehicle VC. The trajectory condition is satisfied when the preceding vehicle VB is traveling along a further preceding vehicle trajectory TR (referring to FIGS. 2 and 6). The further preceding vehicle trajectory TR represents a trajectory traveled by the further preceding vehicle VC. When both of the following condition and the trajectory condition are satisfied, there is a high possibility that the preceding vehicle VB continues to follow the further preceding vehicle VC without changing lanes and continues to travel along the further preceding vehicle trajectory TR, even if the further preceding vehicle VC decelerates. In other words, there is a high possibility that the deceleration of the further preceding vehicle VC is transmitted to the preceding vehicle VB.

Referring to FIG. 2, the method for acquiring the further preceding vehicle TTC is described.

The ECU 20 acquires a subtraction value (Dx2-Lp-Dmin) by subtracting a preceding vehicle length Lp and a minimum inter-vehicle distance Dmin from an inter-vehicle distance Dx2 between the rear end of the further preceding vehicle VC and the front end of the host vehicle VA.

The preceding vehicle length Lp is preset to a value representing a length of the preceding vehicle VB. The minimum inter-vehicle distance Dmin is preset to a value representing the minimum distance between the preceding vehicle VB and the further preceding vehicle VC when the preceding vehicle VB follows the further preceding vehicle VC. It is desirable that the minimum inter-vehicle distance Dmin is preset based on statistical information from ordinary drivers. The above subtraction value represents a distance between the further preceding vehicle VC and the host vehicle VA when it is assumed that there is no preceding vehicle VB.

The ECU 20 acquires the further preceding vehicle TTC by dividing the subtraction value (Dx2-Lp-Dmin) by the relative speed Vr of the further preceding vehicle VC relative to the host vehicle VA. In a case where both of the following condition and the trajectory condition are satisfied, the ECU 20 determines that the collision condition is satisfied when the further preceding vehicle TTC is equal to or smaller than the threshold time Tth, and performs the vehicle control.

Even if the deceleration of the preceding vehicle VB is delayed in response to the deceleration of the further preceding vehicle VC, the further preceding vehicle TTC decrease from a time point at which the further preceding vehicle VC decelerates. Accordingly, even if the deceleration of the preceding vehicle VB is delayed in response to the deceleration of the further preceding vehicle VC, the vehicle control can be performed at an appropriate timing. Furthermore, there is a low possibility that the preceding vehicle VB changes lanes when both of the following condition and the trajectory condition are satisfied, so there is a high possibility that the deceleration of the further preceding vehicle VC is transmitted to the preceding vehicle VB. In the present embodiment, when both of the following condition and the trajectory condition are satisfied, the present apparatus 10 determines whether or not the further preceding vehicle TTC is equal to or smaller than the threshold time Tth. Accordingly, the present apparatus 10 can reduce a possibility that an unnecessary vehicle control is performed when the preceding vehicle VB changes lanes.

### Specific Operation

### Vehicle Control Routine

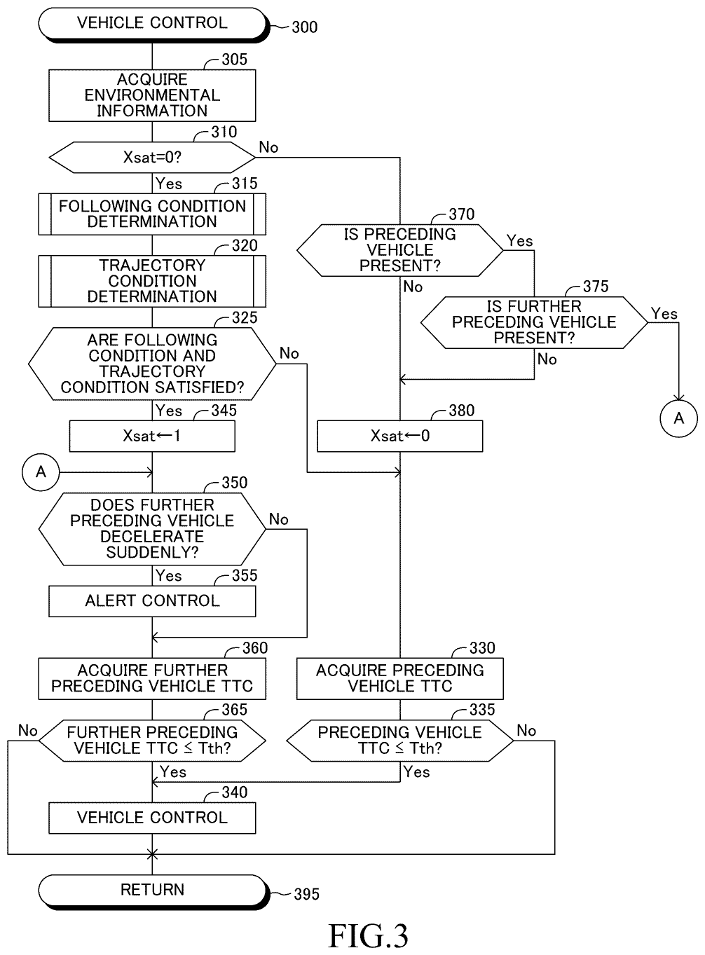

The CPU of the ECU 20 executes a routine shown by a flowchart in FIG. 3 every time a predetermined time elapses.

When an appropriate time point comes, the CPU starts a process from step 300 of FIG. 3, and executes steps 305 and 310.
Step 305: The CPU acquires the camera object information, the white line information, the radar object information, and the LiDAR object information as environmental information regarding to surroundings of the host vehicle VA.
Step 310: The CPU determines whether or not a satisfaction flag Xsat is “0”. The satisfaction flag Xsat is set to “1” when both of the following condition and the trajectory condition are satisfied. The satisfaction flag Xsat is set to “0” when at least one of the following condition and the trajectory condition is not satisfied. The satisfaction flag Xsat is set to “0” in an initialization routine. The initialization routine is executed by the CPU when an ignition key switch (not shown) of the host vehicle VA is turned from an off position to an on position.

When the satisfaction flag Xsat is “0”, the CPU makes a “Yes” determination at step 310 and executes steps 315 to 325.
Step 315: The CPU executes a following condition determination subroutine for determining whether or not the following condition is satisfied. A detailed description of the following condition determination subroutine is described later.
Step 320: The CPU executes a trajectory condition determination subroutine for determining whether or not the trajectory condition is satisfied. A detailed description of the trajectory condition determination subroutine is described later.
Step 325: The CPU determines whether or not both of the tracking conditions and the trajectory conditions are satisfied.

When at least one of the following condition and the trajectory condition is not satisfied, the CPU makes a “No” determination at step 325 and executes steps 330 and 335.
Step 330: The CPU acquires the preceding vehicle TTC.
Step 335: The CPU determines whether or not the preceding vehicle TTC is equal to or smaller than the threshold time Tth.

When the preceding vehicle TTC is greater than the threshold time Tth, the CPU determines that the collision condition is not satisfied. In this case, the CPU makes a “No” determination at step 335, and the process proceeds to step 395. At step 395, the CPU terminates the present routine tentatively.

When the preceding vehicle TTC is equal to or smaller than the threshold time Tth, the CPU determines that the collision condition is satisfied. In this case, the CPU makes a “Yes” determination at step 335 and the process proceeds to step 340. At step 340, the CPU performs the vehicle control. Specifically, the CPU controls the power train actuator 32 and the brake actuator 34 such that an acceleration Ga of the host vehicle VA matches a predetermined negative target acceleration. Thereafter, the process proceeds to step 395 and the CPU terminates the present routine tentatively.

In a case where both of the following condition and the trajectory condition are satisfied when the process proceeds to step 325, the CPU makes a “Yes” determination at step 325 and executes steps 345 and 350.
Step 345: The CPU sets the satisfaction flag Xsat to “1”.
Step 350: The CPU determines whether or not the further preceding vehicle VC decelerates suddenly.

Specifically, the CPU acquires an acceleration Gc of the further preceding vehicle VC by time-differentiating the relative speed Vr of the further preceding vehicle VC. The acceleration Gc is a positive value when the further preceding vehicle VC moves away from the host vehicle VA. The acceleration Gc is a negative value when the further preceding vehicle VC approaches the host vehicle VA. The CPU determines that the further preceding vehicle VC decelerates suddenly when the acceleration Gc is equal to or smaller than a threshold acceleration Gth, which is set to a predetermined negative value.

When the further preceding vehicle VC decelerates suddenly, the CPU makes a “Yes” determination at step 350 and executes steps 355 to 365.
Step 355: The CPU performs an alert control.

Specifically, the CPU displays, on the display device 36, the alert screen for informing the driver that the further preceding vehicle VC decelerates suddenly. Furthermore, the CPU causes the alert sound to be output from the speaker 38.
Step 360: The CPU acquires the further preceding vehicle TTC.
Step 365: The CPU determines whether or not the further preceding vehicle TTC is equal to or smaller than the threshold time Tth.

When the preceding vehicle TTC is greater than the threshold time Tth, the CPU makes a “No” determination at step 365, and the process proceeds to step 395. At step 395, the CPU terminates the present routine tentatively.

When the preceding vehicle TTC is equal to or smaller than the threshold time Tth, the CPU makes a “Yes” determination at step 365 and performs the vehicle control at step 340. Thereafter, the process proceeds to step 395. At step 395, the CPU terminates the present routine tentatively.

In a case where the satisfaction flag Xsat is “1” when the process proceeds to step 310, the CPU makes a “Yes” determination at step 310 and the process proceeds to step 370. At step 370, the CPU determines whether or not the preceding vehicle VB is present. When the preceding vehicle VB is present, the CPU makes a “Yes” determination at step 370 and the process proceeds to step 375. At step 375, the CPU determines whether or not the further preceding vehicle VC is present. When the further preceding vehicle VC is present, the CPU makes a “Yes” determination at step 375 and the process proceeds to step 350.

In a case where the preceding vehicle VB is not present when the process proceeds to step 370, the CPU makes a “No” determination at step 370 and the process proceeds to step 380. At step 380, the CPU sets the satisfaction flag Xsat to “0”. Thereafter, the process proceeds to step 330.

In a case where the further preceding vehicle VC is not present when the process proceeds to step 375, the CPU makes a “No” determination at step 375 and the process proceeds to step 380.

### Following Condition Determination Subroutine

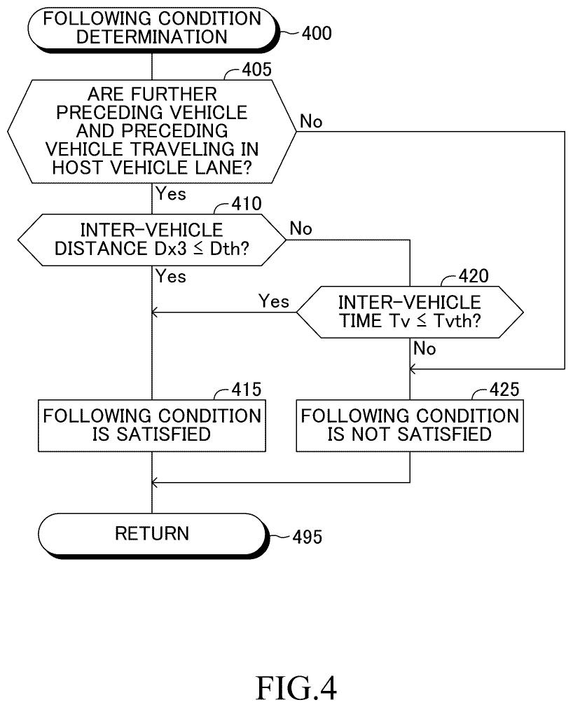

The CPU starts the process from step 400 of FIG. 4 when the process proceeds to step 315 of FIG. 3. Thereafter, the process proceeds to step 405. At step 405, the CPU determines whether or not both of the further preceding vehicle VC and the preceding vehicle VB are traveling in a host vehicle lane SL (referring to FIG. 2). The host vehicle lane SL is a lane (a traveling area) in which the host vehicle VA is traveling.

When both of the further preceding vehicle VC and the preceding vehicle VB are traveling in the host vehicle lane SL, the CPU makes a “Yes” determination at step 405 and the process proceeds to step 410. At step 410, the CPU determines whether or not an inter-vehicle distance Dx3 (referring to FIG. 2) between the rear end of the further preceding vehicle VC and the preceding vehicle VB is equal to or smaller than a predetermined threshold distance Dth.

When the inter-vehicle distance Dx3 is equal to or smaller than the threshold distance Dth, the CPU makes a “Yes” determination at step 410, and the process proceeds to step 415. At step 415, the CPU determines that the following condition is satisfied. Thereafter, the process proceeds to step 495. At step 495, the CPU terminates the present routine tentatively, and the process proceeds to step 320 of FIG. 3.

On the other hand, when the inter-vehicle distance Dx3 is greater than the threshold distance Dth, the CPU makes a “No” determination at step 410 and the process proceeds to step 420. At step 420, the CPU determines whether or not an inter-vehicle time Tv is equal to or smaller than a threshold time Tvth. The inter-vehicle time Tv is a time which it takes for the preceding vehicle VB to travel the inter-vehicle distance Dx3. The inter-vehicle time Tv is acquired by dividing the inter-vehicle distance Dx3 by a speed Vvb of the preceding vehicle VB. The speed Vvb is acquired based on the relative speed Vr of the preceding vehicle VB relative to the host vehicle VA and the vehicle speed Vs of the host vehicle VA.

When the inter-vehicle time Tv is equal to or smaller than the threshold time Tvth, the CPU makes a “Yes” determination at step 420, and the process proceeds to step 415. As a result, the CPU determines that the following condition is satisfied.

On the other hand, when inter-vehicle time Tv is greater than the threshold time Tvth, the CPU makes a “No” determination at step 420 and the process proceeds to step 425. At step 425, the CPU determines that the following condition is not satisfied. Thereafter, the process proceeds to step 495, and the CPU terminates the present routine tentatively. Thereafter, the process proceeds to step 320 of FIG. 3.

In a case where at least one of the further preceding vehicle VC and the preceding vehicle VB is not traveling in the host vehicle lane SL when the process proceeds to step 405, the CPU makes a “No” determination at step 405 and the process proceeds to step 425. As a result, the CPU determines that the following condition is not satisfied.

### Trajectory Condition Determination Subroutine

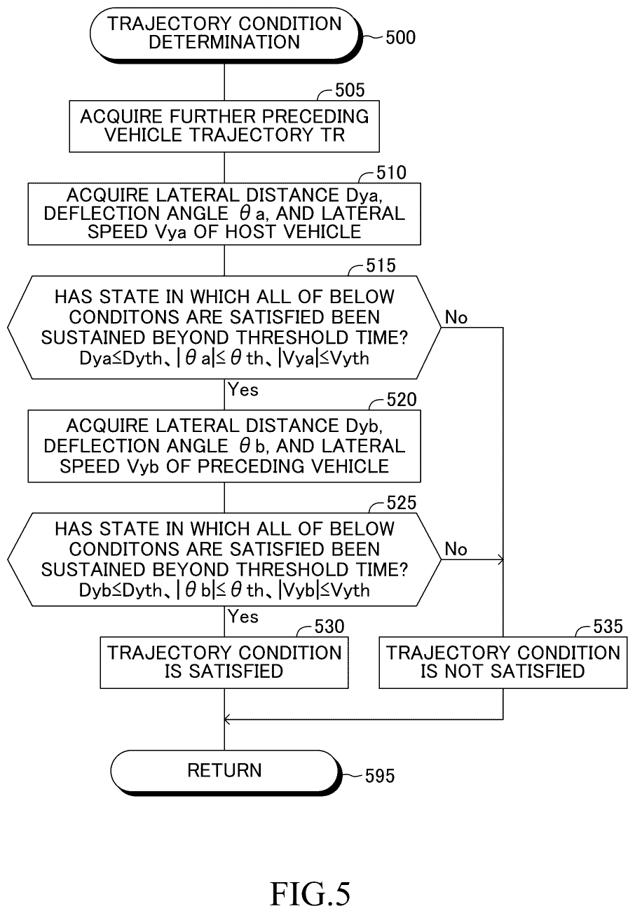

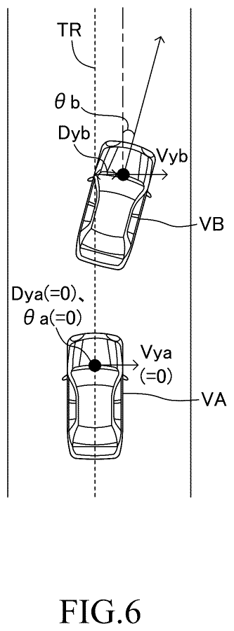

The CPU starts the process from step 500 of FIG. 5 and executes steps 505 to 515 when the process proceeds to step 320 of FIG. 3.
Step 505: The CPU acquires the further preceding vehicle trajectory TR based on history of positions of the further preceding vehicle VC relative to the host vehicle VA.
Step 510: The CPU acquires a lateral distance Dya (referring to FIG. 6), a deflection angle θ (referring to FIG. 6), and a lateral speed Vya (referring to FIG. 6) of the host vehicle VA based on the further preceding vehicle trajectory TR.

The lateral distance Dya represents a distance between the host vehicle VA and the further preceding vehicle trajectory TR in a lateral direction. In an example shown in FIG. 6, the lateral distance Dy is “0”.

The deflection angle θa represents an angle between a longitudinal axis of the host vehicle VA and the further preceding vehicle trajectory TR. In the example shown in FIG. 6, the deflection angle θa is “0”.

The lateral speed Vya represents a speed of the host vehicle VA relative to the further preceding vehicle trajectory TR in the lateral direction.
Step 515: The CPU determines whether or not a state in which all of conditions A1 to A3 are satisfied has been sustained beyond a threshold time. Condition A1: The lateral distance Dya is equal to or smaller than a threshold lateral distance Dyth.
Condition A2: A magnitude of the deflection angle θa is equal to or smaller than a threshold angle θth.
Condition A3: The lateral speed Vya is equal to or smaller than a threshold lateral speed Vyth.

When the state in which all of conditions A1 to A3 are satisfied has been sustained beyond the threshold time, the CPU makes a “Yes” determination at step 515, and executes steps 520 and 525.
Step 520: The CPU acquires a lateral distance Dyb (referring to FIG. 6), a deflection angle θb (referring to FIG. 6), and a lateral speed Vyb (referring to FIG. 6) of the preceding vehicle VB based on the further preceding vehicle trajectory TR.

Regarding to the lateral distance Dyb, the deflection angle θb and the lateral speed Vyb, the “host vehicle VA” in the above explanation of the lateral distance Dya, the deflection angle θa and the lateral speed Vya shall be read as the “preceding vehicle VB”.
Step 525: The CPU determines whether or not a state in which all of conditions B1 to B3 are satisfied has been sustained beyond the threshold time.
Condition B1: The lateral distance Dyb is equal to or smaller than the threshold lateral distance Dyth.
Condition B2: A magnitude of the deflection angle θb is equal to or smaller than the threshold angle θth.
Condition B3: The lateral speed Vyb is equal to or smaller than the threshold lateral speed Vyth.

When the state in which all of conditions B1 to B3 are satisfied has been sustained beyond the threshold time, the CPU makes a “Yes” determination at step 525, and the process proceeds to step 530. At step 530, the CPU determines that the trajectory condition is satisfied. Thereafter, the process proceeds to step 595. At step 595, the CPU terminates the present routine tentatively, and the process proceeds to step 325 of FIG. 3.

In a case where the state in which all of conditions A1 to A3 are satisfied has not been sustained beyond the threshold time when the process proceeds to step 515, the CPU makes a “No” determination at step 515, and the process proceeds to step 535. At step 535, the CPU determines that the trajectory condition is not satisfied. Thereafter, the process proceeds to step 595. At step 595, the CPU terminates the present routine tentatively, and the process proceeds to step 325 of FIG. 3.

In a case where the state in which all of conditions B1 to B3 are satisfied has not been sustained beyond the threshold time when the process proceeds to step 525, the CPU makes a “No” determination at step 525, and the process proceeds to step 535. As a result, the CPU determines that the trajectory condition is not satisfied.

According to the present embodiment, even if the deceleration of the preceding vehicle VB is delayed in response to the deceleration of the further preceding vehicle VC, the possibility that the vehicle control is performed appropriately can be increased, and the possibility that the unnecessary vehicle control is performed can be reduced.

### Modification Example

In the above embodiment, the CPU uses the TTC as the index value representing the collision risk, but the CPU may use a value other than TTC as the index value. For example, the CPU may use “the distance Dx between the object and the host vehicle VA” as the index value. The CPU performs vehicle control when the distance Dx is equal to or smaller than a threshold distance Dxth.

In the above embodiment, the millimeter wave radar 24 detects the further preceding vehicle VC, but a method for detecting the further preceding vehicle VC is not limited to this. For example, a camera 22 arranged on a roof of the host vehicle VA may detect the further preceding vehicle VC. Furthermore, the Lidar 25 arranged at the same position as the millimeter wave radar 24 may detect the further preceding vehicle VC. Furthermore, a sensor for detecting the object is not limited to the camera 22, millimeter wave radar 24 and Lidar 25.

The vehicle control may be a control for changing a steered angle of steered wheels of the host vehicle VA in order to avoid the collision with the object. The vehicle control may be the alert control for informing the driver of the collision risk.

The present apparatus 10 may be applied to (or installed in/on) an engine vehicle, a hybrid electric vehicle (HEV), a plug-in hybrid electric vehicle (PHEV), a fuel cell electric vehicle (FCEV), and a battery electric vehicle (BEV). Furthermore, the preset apparatus may be applied to an automatic driving vehicle.

What is claimed is:

1. A vehicle control apparatus configured to perform a vehicle control for reducing a collision risk representing a possibility that a host vehicle collides with an object when a collision condition is satisfied, the collision condition being satisfied when the collision risk is equal to or greater than a threshold value,
wherein,
the vehicle control apparatus is configured to:
determine whether or not the collision condition is satisfied using a first index value representing the collision risk of a further preceding vehicle when both of a following condition and a trajectory condition are satisfied,
the following condition being satisfied when a preceding vehicle which is present in front of the host vehicle is following the further preceding vehicle which is present in front of the preceding vehicle,
the trajectory condition being satisfied when the host vehicle and the preceding vehicle are traveling along a further preceding vehicle trajectory representing a trajectory traveled by the further preceding vehicle; and
determine whether or not the collision condition is satisfied using a second index value representing the collision risk of the preceding vehicle when at least one of the following condition and the trajectory condition is not satisfied.

2. The vehicle control apparatus according to claim 1,
wherein,
the vehicle control apparatus is configured to determine that the following condition is satisfied when the preceding vehicle is traveling in the same lane as the further preceding vehicle, and either a distance condition or a time condition is satisfied,
the distance condition being satisfied when an inter-vehicle distance between the further preceding vehicle and the preceding vehicle is equal to or smaller than a threshold distance,
the time condition being satisfied when an inter-vehicle time which it takes for the preceding vehicle to travel the inter-vehicle distance is equal to or smaller than a threshold time.

3. The vehicle control apparatus according to claim 1,
wherein,
the vehicle control apparatus is configured to determine that the trajectory condition is satisfied when both of a first condition and a second condition are satisfied,
the first condition being satisfied when a lateral distance of the preceding vehicle relative to the further preceding vehicle trajectory is equal to or smaller than a threshold distance, and a deflection angle of the preceding vehicle relative to the further preceding vehicle trajectory is equal to or smaller than a threshold angle,
the second condition being satisfied when a lateral distance of the host vehicle relative to the further preceding vehicle trajectory is equal to or smaller than the threshold distance, and a deflection angle of the host vehicle relative to the further preceding vehicle trajectory is equal to or smaller than the threshold angle.

4. The vehicle control apparatus according to claim 1,
wherein,
the vehicle control apparatus is configured to:
use, as the first index value, a value acquired by dividing a subtraction value acquired a total of a preceding vehicle length value and a minimum inter-vehicle distance value from an inter-vehicle distance between the host vehicle and the further preceding vehicle by a relative speed of the further preceding vehicle relative to the host vehicle, when both of the following condition and the trajectory condition are satisfied,
the preceding vehicle length value being a value representing a vehicle length of the preceding vehicle,
the minimum inter-vehicle distance value being a value representing a minimum inter-vehicle distance between the preceding vehicle and the further preceding vehicle when the preceding vehicle is following the further preceding vehicle; and
use, as the second index value, a value acquired by dividing a preceding inter-vehicle distance between the host vehicle and the preceding vehicle by a relative speed of the preceding vehicle relative to the host vehicle, when at least one of the following condition and the trajectory condition is not satisfied.
